(19) United States
(12) Patent Application Publication
(10) Pub. No.: US 2026/0348441 A1
(43) Pub. Date: Nov. 5, 2026

(54) BRAKE SYSTEM RETURN MECHANISM

(71) Applicant: AKEBONO BRAKE INDUSTRY CO., LTD., Chuo-ku, Tokyo (JP)

(72) Inventor: Lakshminarayanan VAIDYANATHAN, Farmington Hills, MI (US)

(21) Appl. No.: 19/120,291

(22) PCT Filed: Oct. 10, 2023
(86) PCT No.: PCT/IB2023/060181

§ 371 Date: Apr. 11, 2025

Related U.S. Application Data
(60) Provisional application No. 63/420,232, filed on Oct. 28, 2022.

(51) Int. Cl. F16D 65/18; B60T 13/74; F16D 55/226; F16D 121/14; F16D 121/24; F16D 125/40; F16D 125/48; F16D 125/50; F16D 127/02

(52) U.S. Cl. CPC F16D 65/18; B60T 13/746; F16D 55/226; B60T 2270/40; F16D 2121/14; F16D 2121/24; F16D 2125/40; F16D 2125/48; F16D 2125/50; F16D 2127/02

(57) ABSTRACT

A brake system comprising: (a) a caliper housing (22) supporting a brake pad assembly (24) in communication with a piston; (b) a motor gear unit (40) having a motor in communication with a driving gear (64), wherein during a brake apply operation or a brake release operation, the driving gear (64) moves the brake pad assembly based on power received by the motor; and (c) a plate (74) in communication with the driving gear (40), wherein the plate (74) creates a back-drive force to move the driving gear (40) during the brake release operation, and in turn, directly or indirectly move the brake pad assembly.

### CROSS-REFERENCE TO RELATED APPLICATIONS

The present application is national stage of International Application No. PCT/IB2023/060181, filed Oct. 10, 2023, which claims priority to U.S. Provisional Application No. 63/420,232, filed Oct. 28, 2022, both of which are incorporated herein by reference in their entirety.

### FIELD

The present teachings generally relate to a brake system, and more particularly, to a return mechanism for retracting a brake pad of the brake system.

### BACKGROUND

Various brake systems are used in a wide array of vehicle and/or transportation applications. These brake systems may include one or more pistons, a floating caliper housing or an opposed piston (or fixed) caliper housing, or a combination thereof. Often these brake systems will also include a rotary to linear actuator, such as a ball and nut assembly (BNA).

The BNA may be powered by a motor directly or indirectly connected to the BNA. For example, torque from the motor may be amplified and/or transferred to the BNA using one or more gears to drive the BNA. During a brake apply, the BNA may receive the power and at least a portion of the BNA (e.g., a spindle) may be rotated. This rotation may then be converted through one or more stages in the BNA into a linear movement to drive a piston towards one or more brake pads or shoes, thereby creating a clamping force between the one or more brake pads and a rotor or drum.

Typically, once a brake apply operation is completed, the motor may release the contact between the piston and the one or more brake pads or shoes. To do so, the motor may move the BNA- and any intermediate gears-in a reverse direction to that of a brake apply direction. Advantageously, the BNA may also aid in releasing the piston by providing a backdrive torque itself to reduce the torque required by the motor to release the piston. Such backdrive may be possible due to one or more features of the BNA.

However, in the event of a motor failure, such as the motor not being able to deliver the necessary torque in the apply and/or release directions (e.g., power failure to the motor), the motor may be unable to provide any torque in the reverse direction to release the piston from contacting the one or more brake pads or shoes. As a result, only backdrive provided by the BNA may be available to release the piston. Unfortunately, such backdrive may conventionally not be sufficient to fully release a brake apply (i.e., clamp) force. That is, a portion of the applied force may remain unreleased.

In an attempt to ensure that the brake apply force is released adequately during motor failure to minimize or eliminate contact between the piston and the one or more brake pads or shoes, the BNA may be designed to provide adequate or improved backdrive. For example, the BNA may be designed to increase backdrive to overcome the lack of torque being provided by a failed motor. However, in various circumstances and configurations, it may be impractical or impossible to increase the backdrive of the BNA to sufficiently release the brake apply force. As a result, a portion of the brake apply force may still be present after a release operation is initiated, thereby maintaining contact between the piston and the one or more brake pads or shoes. Such contact may thus result in contact (e.g., drag) between the one or more brake pads or shoes and the rotor or drum. Unfortunately, the drag may then cause degradation to the rotor or drum, the brake system, or both.

Therefore, it would be attractive to have a brake system that allows sufficient release of a piston after a brake apply operation during motor failure. What is needed is a brake system that includes an additional return mechanism that may aid in releasing the piston from contact with one or more brake pads or shoes. Moreover, it would be attractive to have a brake system that includes a return mechanism that may work in conjunction with the BNA to move the piston in a release direction. What is needed is a return mechanism in communication with the BNA that increases torque in the release direction in addition to the backdrive created by the BNA. Furthermore, it would be attractive to have a brake system that increases overall backdrive to decrease a load on the motor during a release operation. Thus, what is needed is a brake system having a return mechanism that improves overall backdrive to increase the life span of the motor due to decreased load during the release operation.

### SUMMARY

The present teachings meet one or more of the present needs by providing a brake system comprising: (a) a caliper housing supporting a brake pad assembly in communication with a piston; (b) a motor gear unit having a motor in communication with a driving gear, wherein during a brake apply operation or a brake release operation, the driving gear moves the brake pad assembly based on power received by the motor; and (c) a plate in communication with the driving gear, wherein the plate creates a backdrive force to move the driving gear during the brake release operation, and in turn, directly or indirectly move the brake pad assembly.

The backdrive force created by the plate may be sufficient to retract the brake pad assembly from a rotor of a vehicle when a motor failure occurs to reduce or eliminate a force applied to the rotor by the brake pad assembly. The plate may be adapted to rotate with the driving gear during the brake apply operation, the brake release operation, or both. The plate may also be adapted to rotate independent of the driving gear, or vice versa, during the brake apply operation, the brake release operation, or both. Moreover, the plate and the driving gear may be coaxial.

The driving gear may include a plurality of pins or projections extending from a surface of the driving gear that interact with one or more fins extending from a surface of the plate. The plurality of pins may contact the one or more fins during the brake apply operation, the brake release operation, or both, so that rotation of the driving gear causes rotation of the plate.

Furthermore, the plate may include a biasing member, and the biasing member may be wound during the brake apply operation so that, during the brake release operation, the biasing member releases the backdrive force to move the driving gear. The biasing member may include a first arm secured by a nib of the plate and a second arm free to move between a pair of stopping points. A first stopping point may be an initial position of the second arm prior to winding of the biasing member, and a second stopping point may be a final position reached by the second arm when the biasing member has been fully wound. When the second arm reaches the second stopping point during the brake apply operation, the plurality of pins of the driving gear may deflect the one or more fins of the plate, thereby allowing the driving gear to continue to rotate independent of the plate.

The biasing member may be secured around a shaft of the plate. The biasing member may be located on an opposing surface of the plate to the surface containing the one or more fins. Furthermore, during the brake release operation, the release of the backdrive force by the biasing member may cause the one or more fins of the plate to rotate and contact the plurality of pins of the driving gear, thereby causing the driving gear to also rotate in the same direction of the plate.

The brake system may include a gear train between the motor and the driving gear, and torque generated by the motor may be transferred through the gear train to the driving gear. Moreover, the motor may include a motor output in communication with the gear train, and an axis of rotation of the motor output may be parallel or perpendicular to an axis of rotation of the driving gear. Additionally, the driving gear may be in communication with a ball and nut assembly so that, during the brake apply operation, the driving gear may drive the ball and nut assembly to contact the piston, whereby the piston may contact the brake pad assembly to move the brake pad assembly towards the rotor of the vehicle.

Furthermore, the shaft of the plate may be secured by a housing of the motor gear unit by a clip. The pair of stopping points of the biasing member may be nibs located on the housing of the motor gear unit. Additionally, the driving gear may include an output shaft extending from a surface of the driving gear that outputs the power received by the motor to move the brake pad assembly, and the plate may be located adjacent to an opposing surface of the driving gear.

The present teachings meet one or more of the present needs by providing: a brake system that allows sufficient release of a piston after a brake apply operation during motor failure; a brake system that includes an additional return mechanism that may aid in releasing the piston from contact with one or more brake pads or shoes; a brake system that includes a return mechanism that may work in conjunction with the BNA to move the piston in a release direction; a return mechanism in communication with the BNA that increases torque in the release direction in addition to the backdrive created by the BNA; a brake system that increases overall backdrive to decrease a load on the motor during a release operation; a brake system having a return mechanism that improves overall backdrive to increase the life span of the motor due to decreased load during the release operation; or a combination thereof.

### BRIEF DESCRIPTION OF THE DRAWINGS

FIG. 1 is a perspective view of a brake system.

FIG. 2 is perspective view of a brake system with the motor gear unit (MGU) housing removed.

FIG. 3 is a cross-sectional view of a brake system in accordance with the present teachings.

FIG. 4 is a perspective view of a driving gear in communication with a gear train of a brake system in accordance with the present teachings.

FIG. 5 is a perspective view of a motor gear unit (MGU) housing in accordance with the present teachings.

FIG. 6 is a perspective view of a driving gear in communication with a plate in accordance with the present teachings.

FIG. 7 is a perspective view of a driving gear in communication with a plate in accordance with the present teachings.

FIG. 8 is a perspective view of a driving gear in communication with a plate in accordance with the present teachings.

FIG. 9 is a perspective view of a driving gear in communication with a plate in accordance with the present teachings.

FIG. 10 is a perspective view of a driving gear in communication with a plate in accordance with the present teachings.

FIG. 11 is a perspective view of a driving gear in accordance with the present teachings.

FIG. 12 is a perspective view of a plate in communication with a motor gear unit (MGU) housing in accordance with the present teachings.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference in their entirety for all purposes. Other combinations are also possible as will be gleaned from the following claims, which are also hereby incorporated by reference in their entirety into this written description.

The present teachings generally relate to a brake system. The brake system may be a system or assembly for creating a clamping force during a brake apply operation. The brake system may be any system or assembly for releasing a clamping force. The brake system may function to, may be configured to, or may be adapted or enabled to create a clamping force to slow, stop, and/or maintain a vehicle in a stopped position. The clamping force may be used during a service brake operation to slow, stop, and/or maintain a vehicle in a stopped position. The clamping force may be used during a parking brake operation to maintain a vehicle in a stopped or parked position. The clamping force may be used during both a service and parking brake operation. The brake system may have a hydraulic component, where hydraulic fluid is used to move a brake piston and brake pad against a braking surface (i.e., brake rotor) to create a clamping force during a service and/or parking brake operation. The hydraulic component may be applied together with the torque distributing assembly disclosed herein or separately.

The brake system may be an opposed brake system (i.e., a fixed caliper brake system) or a floating brake system (i.e., a floating caliper). The brake system may be a plate brake system. The brake system may be a drum brake system. The brake system may be a service brake system. The brake system may be a parking brake system.

The clamping force may be a force that, when coupled with a brake pad or brake shoe coefficient of friction, functions to decelerate, slow, stop, and/or prevent movement or rotation of a brake rotor, brake drum, and/or a vehicle. The clamping force may be created during a standard brake apply (i.e., a brake apply force). The clamping force may be created during a parking brake apply (i.e., a parking brake force).

The brake system may include one or more brake pad assemblies and a caliper housing at least partially supporting the one or more brake pad assemblies. During a brake apply operation, one or more pistons located within or supported by the caliper housing may be moved towards and away from the one or more brake pads by pressurizing brake fluid. Additionally, or alternatively, during a brake apply operation, the one or more pistons and one or more brake pad assemblies may be moved with electromechanical elements to create the clamping force. Such electromechanical elements may include a rotary to linear mechanism, spindle, nut, motor, one or more gears, a torque distributing assembly, a plate having a biasing member, or a combination thereof.

A brake rotor may cooperate with the components of the brake system to create the clamping force. The brake rotor may include an inboard side and an opposing outboard side. The caliper housing may be arranged so that one or more brake pads are located at the inboard side of the brake rotor (i.e., inboard brake pads), and one or more brake pads are located at the outboard side of the brake rotor (i.e., outboard brake pads), or both.

The caliper housing may include one or more piston housings. The piston housings may define a hollow region in the caliper housing configured to receive and support a corresponding brake piston. The piston housings may be located entirely on one side of the brake rotor (i.e., inboard side or outboard side), or on both sides of the brake rotor.

The brake system may have one or more pistons. The pistons may function to move a brake pad assembly, or a corresponding end of a brake pad assembly, towards the brake rotor to create the clamping force during the brake apply operation. The pistons may be located on one side of the brake rotor (i.e., inboard side or outboard side), or one or more pistons may be located on each side of the brake rotor.

During a brake apply operation, to decelerate, slow, stop, or maintain a vehicle in a stopped or parked position, the brake pistons may be moved by pressurizing fluid, such as brake fluid. To release the clamping force or the brake apply, the brake pistons may be moved by depressurizing the fluid. During a brake apply, to decelerate, slow, stop, or maintain a vehicle in a stopped or parked position, the brake pistons may be moved with one or more electromechanical mechanisms (e.g., with one or more rotary to linear mechanisms; spindles; nuts; motors; plates; etc.).

The one or more pistons may also include a pocket or cavity therein that may function to receive at least a portion of a corresponding rotary to linear stage mechanism (e.g., a ball and nut assembly). The piston pocket may be a cup or recess formed into an end of a piston. The piston pocket may include a bottom wall at the end or bottom of the piston pocket and an opposing open end. A gap may exist between a nut of the rotary to linear stage mechanism and a corresponding bottom wall. During a brake apply operation, the gap may be taken up by moving the rotary to linear stage mechanism towards the bottom wall. Once the gap is taken up, further movement of the nut or rotary to linear stage mechanism may cause the or the rotary to linear stage mechanism to press against the bottom wall and then move the brake piston and thus the brake pad assembly against the brake rotor to create the clamping force.

The one or more brake pad assemblies may be used to create the clamping force. The clamping force may create a transfer of energy by converting the kinetic energy of the vehicle into thermal energy by frictionally engaging one or more brake pad assemblies with one or more sides of the brake rotor. The one or more brake pad assemblies may include one or more features (i.e., ears, projections, etc.) that may engage or be engaged by the caliper housing, a support bracket, or both to maintain the location of the brake pad assemblies within the braking system and relative to the brake rotor.

The one or more brake pad assemblies may include one or more components. The brake pad assemblies may include a friction material adapted to contact the brake rotor and create the clamping force. The friction material may be supported or positioned by a shim disposed on a surface of the friction material that opposes a surface of the friction material that contacts the brake rotor. Similarly, the shim and the friction material may both be supported by a pressure plate. The pressure plate may be a supporting portion of the brake pad assemblies that receives input from pistons to move the brake pad assemblies. That is, the piston may contact the pressure plate so that the pressure plate moves the friction material towards the brake rotor. By moving the rotary to linear mechanism (e.g., a nut therein) away from contact the piston within the piston pocket, the piston itself may move in an opposed, release direction, so that the brake pad assemblies can move away from the brake rotor, thereby releasing the clamping force. Such a release direction of the brake pad assemblies may oppose a direction of movement of the brake pad assemblies during the brake apply (e.g., clamping) operation.

The brake system may include a motor gear unit (MGU). The MGU may function to generate a force or torque and transfer the force or torque into the rotary to linear mechanism to drive the rotary to linear mechanism towards the piston, thereby creating the clamping force. The MGU may also function to move the rotary to linear mechanism away from the piston during a release operation. The MGU may include one or more components that generate the force or torque, transfer the force or torque, or both.

The MGU may include one or more motors. The motor may be any motor for creating a force or torque. For example, the motor may be a DC motor, a brushless motor, a series-wound motor, a shunt wound motor, a compound wound motor, a separately exited motor, a servomotor, a stepping motor, or a permanent magnet motor. The motor may include one or more electrical leads, terminals, connections, or plugs for connecting the motor to a power source, computer, processor. Supplying power to the motor may cause an output of the motor to rotate about an axis. The output of the motor may be a shaft, gear, other mechanism, or a combination thereof extending from the motor and adapted to rotate in an apply direction (i.e., to create a clamping force) and an opposing release direction (i.e., to release the clamping force).

The output of the motor may be in communication with a gear train of the MGU. The gear train may function to transfer the force or torque generated from the motor to the rotary to linear mechanism (e.g., a ball and nut assembly). The gear train may include one or more gears meshably engaged with the output of the motor such that rotation of the motor output results in rotation of the one or more gears. The one or more gears may be any number of gears desired to transfer the force or torque from the motor output to the rotary to linear mechanism. The one or more gears may vary in size (e.g., diameter, thickness, both), number of teeth thereon, size of the teeth, or a combination thereof to effectively and/or efficiently transfer the force or torque from the motor to the rotary to linear mechanism. The one or more gears may be positioned anywhere relative to each other to transfer the force or torque through gear train.

As discussed above, the brake system may include one or more rotary to linear mechanisms, which may also be referred to as rotary to linear stage mechanisms. By way of example, the rotary to linear mechanisms may be a ball and nut assembly (BNA). The BNA may be a high-efficiency device such as a ball screw, a roller screw, a ball ramp, etc., or may be a low-efficiency device such as a lead screw. The BNA may function to convert the force or torque output from the motor into a linear or axial force to move the one or more pistons.

Additionally, it is envisioned that the BNA may provide a backdrive force such that, during a brake release operation, the backdrive force may at least partially move the BNA in a release direction, thereby at least partially releasing a clamping force between the brake pad assemblies and the brake rotor. Such backdrive may be made possible or facilitated by one or more balls, one or more ball springs, one or more bushings, or a combination thereof located within the BNA. Such backdrive may also generally be made possible by a spindle and a nut of the BNA.

The spindle may be rotated by the motor or a corresponding driving gear. The spindle may be rotated in an apply direction and a release direction to apply and release the brake system, respectively. Rotation of the spindle may cause a nut threadedly engaged with the spindle to move axially along an axis in an apply or release direction to move the brake pads towards or away from the brake rotor. The spindle may be driven directly by a driving gear (e.g., direct connection or attachment between the two elements). The spindle may be driven indirectly by a driving gear (e.g., indirect connection or attachment between the two elements, meaning one or more gears, shafts, belts, chains, or other intermediate connection members are provided between the spindle and the driving gear).

The spindle may include an engaging portion the receives input from the driving gear directly or indirectly to rotate the spindle about an axis of rotation. The engaging portion of the spindle may be an end portion of the spindle adjacent to the driving gear or corresponding driving mechanism.

The nut may be moved axially along an axis that the spindle is configured to rotate about. For example, the nut and the spindle may be threadedly engaged such that when the spindle is rotated by the motor or driving gear, the nut moves axially toward or away from a wall of the piston pocket. After contact between the nut and the piston pocket wall is made, further movement of the nut may result in movement of a piston and thus a brake pad assembly, or a corresponding end of a brake pad towards a brake rotor. The nut may also be restricted or prevented from rotating about the axis along which it is configured to axially move.

As stated above, the rotary to linear mechanism (e.g., the BNA) may be driven by one or more driving gears. The driving gear my function to transfer the force or torque from the motor or the gear train to the corresponding spindle of the BNA. The driving gear may frictionally engage a corresponding spindle. The driving gear may engage a corresponding spindle via spines and corresponding notches defined on the receiving portion of the spindle and/or the driving gear.

The driving gear may be in communication with the gear train or may be part of the gear train. In either case, the driving gear may be a gear that receives the force or torque from the gear train or directly from the motor to transfer the force or torque directly or indirectly to the BNA. To transfer the force or torque, the driving gear may include an output.

The output may be a shaft or gear extending from the driving gear towards the BNA. The output may directly engage the spindle (e.g., the engaging portion thereof) or may indirectly communicate with the spindle to rotate the spindle. The output of the driving gear may rotate about an axis of rotation. Such an axis may be parallel to, or coaxial with, the axis of rotation of the spindle, the axis of rotation of the motor output, or a combination thereof. The output may be a gear in communication with one or more additional gears that contact the spindle to rotate the spindle.

By way of example, the output of the driving gear may be a sun gear in communication with one or more planet gears of a planetary gear system. As the sun gear rotates due to rotation of the driving gear, the one or more planet gears may also rotate, thereby rotate a member or component in communication with the spindle. As a result, the spindle may in turn rotate.

The driving gear may also be in communication with plate. The plate may function to aid in release of the one or more brake pad assemblies during the release operation. The plate may function to rotate the driving gear in a brake apply direction, a brake release direction, or both. The plate may be adapted to rotate simultaneous with the driving gear. The plate be adapted to rotate independently of the driving gear, or vice versa. As such, the plate and the driving gear may be rotatably engaged to one another to facilitate such rotation.

To facilitate such rotation of the plate and the driving gear, the plate may include a shaft. The shaft may project or extend through the plate to communicate with the driving. The shaft may project or extend through the plate to connect a motor gear unit (MGU) housing to the plate. The shaft may extend through the MGU housing to maintain an axial position of the MGU housing along an axis of rotation of the plate. To secure the MGU housing axially along the shaft, one or more clips or fasteners may be secure to the shaft and/or the MGU housing.

The shaft may rotatably connect the plate and the driving gear so that the plate and the driving gear are coaxial. As a result, the plate and the driving gear may share an axis of rotation. The axis of rotation of the plate and the driving gear may be parallel to, or coaxial with, the axis of rotation of the spindle of the BNA.

The plate may rotate the driving gear, the driving gear may rotate the plate, or both. The plate may engage the driving gear during rotation of the plate, or the driving gear may engage the plate during rotation of the driving gear.

The driving gear may include one or more pins that engage the plate during rotation. The one or more pins may project or extend from a surface of the driving gear toward the plate. The one or more pins may communicate with one or more fins of the plate so that, when the one or more pins contact the one or more fins during rotation of the driving gear, the plate may also rotate in the same direction as the driving gear.

The one or more pins may be a plurality of pins. The pins of the driving gear may be positioned anywhere along the surface of the driving gear. The pins may be located around or near a peripheral edge of the driving gear. The pins may be located near a central portion or center hole of the driving gear towards an axis of rotation of the driving gear. The pins may be formed with the driving gear or may be connected to the driving gear. The pins may be formed in any shape (e.g., any length as measured from a distal end to the surface of the driving gear, any diameter, any curvature, etc.). The pins may be shaped to ensure contact between the pins and the one or more fins of the plate during rotation of the driving gear, rotation of the plate, or both.

The one or more fins of the plate may project or extend from a surface of the plate. The surface of the plate including the one or more fins may face the surface of the driving gear that includes the one or more pins. As stated above, the one or more fins may be contacted by the one or more pins during rotation of the driving gear so that, as the driving gear rotates, the plate also rotates in the same direction. Such rotation may be done during a brake apply operation where the driving gear is being driven by the motor to rotate the rotary to linear mechanism.

Similarly, the plate may initiate rotation of the driving gear. That is, the plate may rotate so that the one or more fins contact the one or more pins of the driving gear. As a result, the driving gear may be rotated in the same direction of rotation of the plate. Such rotation may be done during a brake release operation where the driving gear is being moved in a release direction by the motor. However, beneficially, the plate may also provide a means for rotating the driving gear in the release direction independent of the motor. In other words, if the motor were to have a failure and be rendered inoperable or otherwise be unable to drive the driving gear in the brake apply direction, the brake release direction, or both, the plate may create a sufficient force or torque to rotate the driving gear in the release direction. The force or torque created by the plate may be sufficient to rotate the rotary to linear mechanism (e.g., the BNA) in a release direction to disengage the one or more brake pad assemblies from the brake rotor.

The one or more fins of the plate may facilitate rotation of the driving gear in the release direction. Additionally, the one or more fins may allow rotation of the driving gear free or independent of rotation of the plate. To do so, the one or more fins may be compressible, flexible, elastic, moveable, or a combination thereof. Such compression, flexibility, elasticity, moveability, or a combination thereof may be present when a force applied to the one or more fins reaches or exceeds a designated threshold.

For example, during a brake apply operation, the pins of the driving gear may contact the one or more fins of the plate during rotation of the driving gear, thereby also rotating the plate in the same direction as the driving gear. Once the driving gear is rotated a desired amount or reaches a stopping point in the brake apply or clamping direction, the plate may be prevented from rotating any further in the brake apply or clamping direction. As a result, the pins and driving gear may remain being driven by the motor so that a force on the now stationary one or more fins of the plate applied by the pins of the driving gear may increase. Once such a force increases over the designated threshold force, the one or more fins may deflect to allow the driving gear to continue to rotate in the brake apply or clamping direction.

To accommodate the aforementioned capabilities of the fins, the fins may have any desired shape, length, height, width, etc. The fins may include one or more linear segments, one or more arcuate segments, one or more curves, one or more notches, one or more grooves, one or more points, one or more tips, one or more bases, or a combination thereof. The fins may have one or more arms, one or more fingers, or both. The fins may be tuned or shaped to create the desired force threshold for deflection based upon a given brake system application.

The fins may be reinforced. Reinforcement may be locally done along only portions of the fins or may be done along an entirety of the fins. Only a portion of the fins may be reinforced, or all of the fins may be reinforced. In certain applications, the fins may also be free of reinforcement. However, when reinforcement is incorporated into the fins, the reinforcement may be a locally increased thickness of the fins, a reinforcing feature of the fins (e.g., a gusset, rib, arm, etc.), a secondary material connected or disposed to the fins, or a combination thereof.

As discussed above, the plate through the one or more fins may rotate the driving gear, and in particular, rotate the driving gear in a brake release direction. To do so, the plate may generate or otherwise store a force or torque that may be applied to the driving gear to rotate the driving gear. Such a force or torque may be generated and/or stored in a biasing member of the plate.

The biasing member may function to generate the force or torque. The biasing member may function to rotate the plate using the generated force or torque, thereby allowing the plate to contact the driving gear and rotate the driving gear. The force or torque may be stored in the biasing member. The force or torque may be generated by moving or applying a load to the biasing member. The movement of the biasing member or the load applied to the biasing member may be done during the brake apply operation so that the force or torque generated and stored in the biasing member may be released during the brake release operation.

For example, the biasing member may be an elastic member. The elastic member may be stretched during rotation of the plate during the brake apply operation. The stretching may create a force or torque being stored within the biasing member. When the brake system commences the brake release operation, the plate may begin rotating in a release direction, thereby releasing the force or torque stored in the elastic member. As a result, the released force or torque may also aid in rotating the driving gear in the release direction.

While the biasing member as described herein may be connected to, or otherwise in communication with, the plate of motor gear unit, it is envisioned that the biasing member may be located anywhere within the brake system. That is, the biasing member may be located or adapted for engagement with any gear within the gear train, may be located or adapted for engagement with one or more driving gears, or both. Similarly, the biasing member may be located adjacent to the gear train, the one or more driving gears, or both so that the biasing member may communicate with the motor gear unit without being displaced directly on any gear within the motor gear unit. That is, the biasing member may be a separate mechanism in communication with the motor gear unit.

The biasing member may be a spring. The spring may be a coil spring, a torsion spring, helical spring, disk spring, leaf spring, spiral spring, extension spring, compression spring, or a combination thereof.

The biasing member may be secured to the plate. The biasing member may include a coiled or wound portion that is at least partially wound around the shaft of the plate. The biasing member may be mounting or otherwise clamped to the plate. The biasing member may be disposed along a surface of the plate that opposes the surface of the plate having the one or more fins.

The biasing member may include one or more arms. The arms may function to engage one or more features of the plate, one or more features of the MGU housing, or both. The arms may be fixed or may be free to move. The arms may extend from a central portion of the biasing member to contact the one or more features of the plate, the one or more features of the MGU housing or both. The one or more features may be a clamp, clip, nib, bumper, engaging feature, stopper, etc. of the plate and/or the MGU housing that may prevent movement of the one or more arms entirely or in a desired direction.

For example, the biasing member may include a first arm and a second arm extend away from a central coiled portion of the biasing member. The first arm may engage a nib or bumper that prevent movement entirely of the first arm. Conversely, the second arm may be located between opposing bumper or nibs located along the plate or the MGU housing so that the second arm may freely move between the opposing bumpers or nibs. The opposing bumpers or nibs associated with the second arm may determine stopping points of the second arm during moving of the second arm when completing a brake apply operation, a brake release operation, or both.

The arms of the biasing member may be linear, may include one or more arcuate sections, may include one or more fingers, may include one or more projections, or a combination thereof to engage the plate, the MGU housing, or both.

It should be noted that the MGU housing disclosed herein may be adapted to house or contain all or a portion of the motor gear unit (e.g., the motor, gear train, driving gear, plate, etc.). The MGU housing may include one or more portions interconnected to form the housing. The MGU housing may include one or more openings, one or more doors, one or more panels, one or more covers, or a combination thereof. The MGU housing may include one or more recesses or channels that receive some or all of the components of the MGU. The MGU housing may include one or more features that communicate with the MGU. The one or more features may be one or more nibs or bumpers, one or more clips, one or more holes, one or more projections, one or more ribs, etc.

It should be noted that any gear disclosed herein (e.g., the motor output, the driving gear, the driving gear output, gears within the gear train, the planetary gear system, etc.) may be replaced by two or more gears. Any two or more gears disclosed herein may be replaced by a single gear. One or more intermediate gears may be provided between any two or more gears disclosed herein as directly meshingly engaging one another. Any intermediate gear disclosed herein between two or more other gears may be eliminated.

Any gear disclosed herein may be a spur gear, helical gear, bevel gear, worm gear. In other words, for example, while reference may be made to a spur gear, the spur gear may be replaced with any gear, such as a helical gear.

While the gears disclosed herein are described as having teeth that mesh with or meshingly engage other teeth gears to transmit torque between the gears, it is understood that other means can be used to transmit torque such as, for example, using one or more belts, chains, intermediate gears, shafts, rack and pinions, axles, etc. Moreover, in certain applications, the teeth on one or more of the gears may be eliminated and the gears may engage one another via a pressure or friction fit to transmit torque. Furthermore, any gear disclosed herein may be replaced with a shaft, belt, chain, or other torque transmitting means. Furthermore, any of the gears and their orientation disclosed herein may be rearranged and still be within the scope of this disclosed.

The gears and/or the plate disclosed herein may be made of any material, such as metal, plastic, 3D printed, etc.

One or more bearings and/or bushings may be provided at any interface where one or more gears and/or the plate are described as rotating about a shaft or axis.

The brake system and/or clamping force disclosed herein may be utilized for any vehicle (i.e., passenger or cargo car, truck, utility, or off-road vehicle). The brake system and/or clamping force disclosed herein may be utilized for service brake applications (i.e., to slow, stop, or prevent movement of a road wheel or vehicle). The brake system and/or clamping force disclosed herein may be utilized for parking brake applications (i.e., to prevent movement of a road wheel or vehicle). The brake system and/or clamping force disclosed herein may be utilized for parking brake applications while a hydraulic or other brake system is utilized for service brake operations.

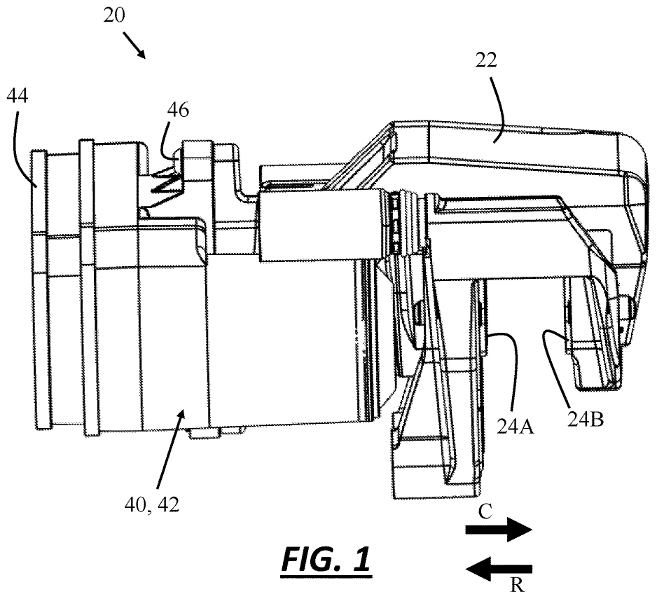

Turning now to the figures, FIG. 1 illustrates a perspective view of a brake system 20 in accordance with the present teachings. The brake system 20 may include a caliper housing 22 that at least partially contains one or more brake pad assemblies 24. As shown, the caliper housing 22 may include a first brake pad assembly 24A and a second brake pad assembly 24B. The first brake pad assembly 24A and the second brake pad assembly 24B may be located on opposing sides of a rotor (not shown) when the rotor is partially contained within the caliper housing 22. As a result, the brake pad assemblies 24 may be configured to contact the rotor during a brake apply operation.

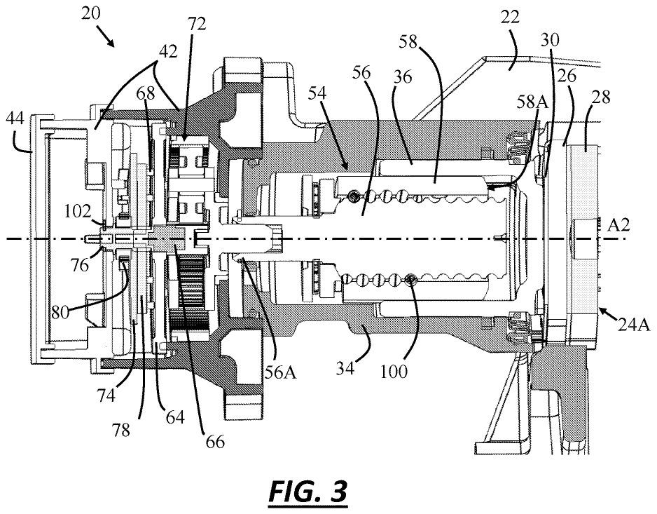

To facilitate the brake apply operation, the brake system 20 may include a motor gear unit (MGU) 40 contained within an MGU housing 42. As described in further detail below, the MGU 40 may include a motor in communication with one or more gears such that a driving gear may drive a ball and nut assembly (BNA) contained within the caliper housing 22 into contact with a piston (see, e.g., FIG. 3). As a result, the piston may be driven into contact with the first brake pad assembly 24A so that the first brake pad assembly 24A moves in the clamping direction (C) to contact the rotor. Similarly, as the first brake pad assembly 24A moves the clamping direction (C), the second brake pad assembly 24B may move in an opposing direction to contact an opposing side of the rotor. As a result, the brake pad assemblies 24 may clamp the rotor and create a braking force. Once the brake apply operation is completed, the first brake pad assembly may be released and moved in a release direction (R) to be free of contact with the rotor. Similarly, the second brake pad assembly 24B may move in a direction opposing the release direction (R) to also be free of contact with the rotor.

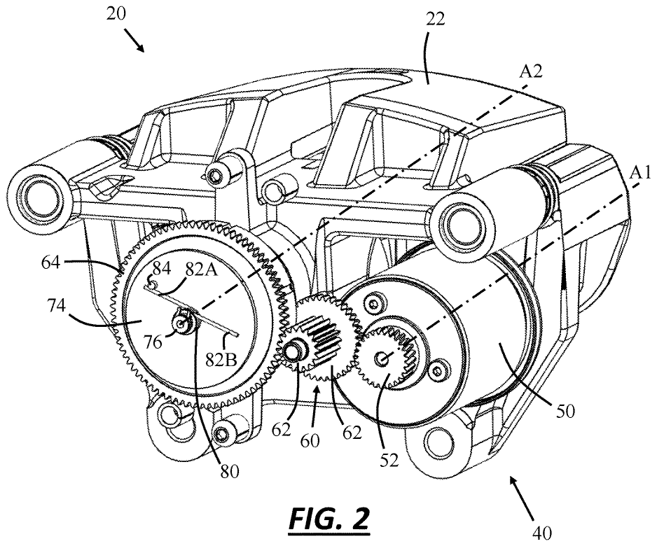

FIG. 2 illustrates a perspective view of the brake system 20 shown in FIG. 1. For simplicity and clarity, the motor gear unit (MGU) housing has been removed. As described above, the brake system 20 may include a caliper housing 22 containing one or more brake pad assemblies configured to clamp a rotor of a vehicle.

The brake pad assemblies may be moved in a clamping direction (i.e., towards the rotor), in a release direction (i.e., away from the rotor), or both based upon torque being generated from a motor 50 of the motor gear unit (MGU) 40. As shown, the motor 50 may include a motor output 52 that outputs the torque generated from the motor 50. The motor output 52 may be a gear or other mechanism in communication with the motor 50. To output the torque, the motor output 52 may be adapted to rotate about an axis (A1). The axis (A1) may be the axis of rotation of the motor 50 or may be a different axis. For example, the axis (A1) may be parallel to or offset in some manner from the axis of rotation of the motor 50. However, it is envisioned that the motor output 52 may be arranged about the axis of rotation of the motor 50 (i.e., axis (A1) is the axis of rotation of the motor) to efficiently and effectively translate the torque generated from the motor 50.

The motor output 52 may be in communication with a gear train 60 of the MGU (40). The gear train 60 may include one or more gears 62 interconnected or otherwise in communication with one another to transfer a torque from the motor output 52 through the gear train 60. That is, the motor output 52 may be meshed with at least one gear 62 of the gear train 60 to transfer the torque generated from the motor 50 to the gear 62. As a result, the gear 62 in communication with the motor output 52 may then transfer the torque generated to the one or more additional gears within the gear train 60, thereby allowing for the torque generated from the motor 50 to travel along the entirety of the gear train 60. It should be note that the gear train 60 may include any number of—and variety of—gears 62. Those skilled in the art would appreciate that a variety of gear train 60 configurations may be possible or desired based upon a particular brake system 20 or vehicle application.

The gear train 60 may receive the torque from the motor output 52 and transfer such torque to a driving gear 64. That is, the torque output from the motor 50 through the motor output 52 may travel through the gear train 60 until it is received by the driving gear 64. As a result, the driving gear 64 may transfer the torque to the ball and nut assembly (BNA; not shown) by rotating about an axis of rotation (A2) of the driving gear 64, thereby allowing the BNA to move the piston of the brake system 20 into contact with one or more brake pad assemblies (see FIGS. 1 and 3). As shown in FIG. 2, the axis of rotation (A2) of the driving gear 64 may be offset from the axis of rotation (Al) of the motor 50 and/or the motor output 52. The axes (A1, A2) may be parallel to one another, may converge toward one another, or may diverge from one another. However, as shown, it is envisioned that the axis of rotation (A2) of the driving gear 64 may be parallel to the axis of rotation (A1) of the motor 50 to efficiently transfer the torque generated by the motor 50.

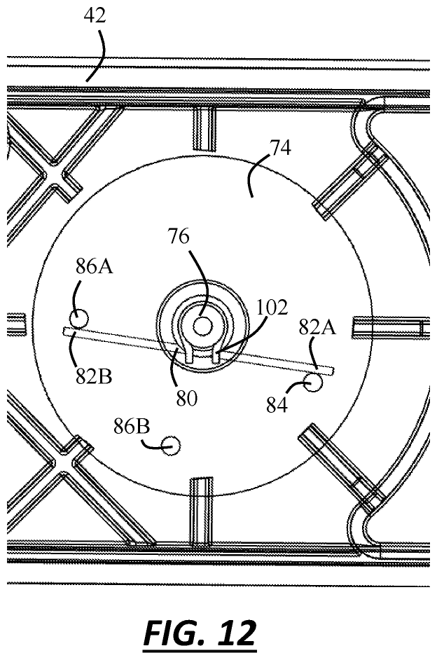

The driving gear 64 may also be in communication with a plate 74 located adjacent to the driving gear 64. The plate 74 may be located on an opposing side of the driving gear 64 relative to the BNA of the brake system 20. The plate 74 may also be configured to rotate about the axis of rotation (A2) of the driving gear 64. Additionally, the plate 74 may include a shaft 76 extending through the plate 74 and the driving gear 64. The shaft 76 may be configured to maintain a lateral location of a biasing member 80 while also facilitating rotational movement of the plate 74 and the driving gear 64 relative to each other. For example, the biasing member 80 may be at least partially wrapped around the shaft 76. The biasing member 80 may also include a first arm 82A abutting a nib 84 of the plate 74 and a second arm 82B configured to contact one or more nibs located on the housing of the MGU (see FIG. 12).

FIG. 3 illustrates a cross-sectional view of a brake system 20 in accordance with the present teachings. The brake system 20 may include a caliper housing 22 housing one or more brake pad assemblies 24. For simplicity, while the caliper housing 22 may include opposing brake pad assemblies 24, only the first brake pad assembly 24A is shown. The brake pad assembly 24A may include a friction material 28 secured to a shim 30 and/or a pressure plate 26. As a result, a piston 36 of the brake system 20 located within a piston housing 34 of the caliper housing 22 may contact the pressure plate 26 and move the friction material 28 to contact a rotor of a vehicle.

To drive the piston 36, the brake system 20 may include a ball and nut assembly (BNA) 54. The BNA 54 may include a nut 58 threadedly engaged to a spindle 56 so that rotation of the spindle 56 may result in linear movement of the nut 58 until a contact surface 58A of the nut 58 contacts the piston 36 and moves the piston 36 towards the pressure plate 26. Rotation of the spindle 56 may be accomplished by a driving gear 64 of the brake system 20. In particular, the driving gear 64 may include an output 66 in communication with an engaging portion 56A of the spindle 56. The output 66 of the driving gear 64 may be connected with a planetary gear system 72 that translates rotation of the driving gear 64 into rotation of the spindle 56. As a result, rotation of the driving gear 64 may drive the spindle 56 to rotate about an axis of rotation (A2). As shown, it should be noted that the axis of rotation (A2) of the spindle 56 may also be the axis of rotation (A2) of the driving gear 64.

Driving of the driving gear 64 may be facilitated by a motor gear unit (MGU) of the brake system 20 located within an MGU housing 42 and/or a cover 44. More specifically, a motor of the MGU may generate a torque that is translated through a gear train and into the drive gear 64, ultimately driving the BNA 54 thereafter to contact the piston 58 and move the first brake pad bad assembly 24A (see FIG. 2). That is, during a brake apply operation, movement of the one or more brake pad assemblies may be generated substantially or entirely by the motor.

Conversely, during a release operation in which the brake pad assemblies are moved away from the rotor of the vehicle towards a starting position, the motor may work in conjunction with the BNA 54. In particular, the BNA 54 may include one or more ball springs 100 that allow for the BNA 54 to freely generate a backdrive force (i.e., torque) through the spindle 56 to aid with releasing the brake pad assemblies. For example, the ball springs 100 (or individual balls in certain assemblies) may be located between the nut 58 and the spindle 56 so that, when the nut 58 is pressed against the piston 58 and brake system 20 is released to begin retraction of the piston 58, the ball springs 100 may promote the spindle 56 to freely rotate in a release direction (i.e., opposite a direction of rotation for clamping). As a result of the backdrive generated through the BNA 54, the motor of the brake system 20 may be required to generate less torque in the release direction.

However, in certain circumstances of motor failure (e.g., power failure and/or mechanical failure of the motor), the backdrive generated from the BNA 54 alone may be unable to release the brake pad assemblies enough to disengage the rotor of the vehicle. That is, without the motor generating a torque in the release direction, the backdrive may be insufficient to release the brake pad assemblies. To accommodate for these instances, the brake system 20 may advantageously include a plate 74 in communication with the driving gear 64.

The plate 74 may include a shaft 76 extending through the plate 74 and in communication with the driving gear 64 to allow for rotational movement of the plate 74 and the driving gear 64 relative to each other. The driving gear 64 may include a plurality of pins 68 that project from a surface of the driving gear 64 toward the plate 74. During a brake apply operation, the pins 68 may contact one or more fins 78 projecting from a surface of the plate 74 towards the driving gear 64 so that rotation of the driving gear 64 may also rotate the plate 74 about the axis of rotation (A2). Additionally, while discussed in further detail below, the plate 74 being rotated by the driving gear 64 may cause a biasing member 80 wrapped around the shaft 76 of the plate and secured with a clip 102 to be wound (e.g., torqued).

If the motor of the brake system 20 were to fail, the backdrive of the BNA 54 may begin to rotate in a release direction to disengage the brake pad assemblies from the rotor of the vehicle. Beneficially, during such backdriving, the biasing member 80 may also be unwound to release the loaded torque therein caused by the brake apply operation. By unwinding the biasing member 80, the one or more fins 78 of the plate 74 may contact the pins 68 of the driving gear 64, thereby driving the driving gear 64 to rotate in a release direction the same as the plate 74. Thus, the biasing member 80 may work in conjunction with the backdrive of the BNA 54 to increase the torque during a release operation to sufficiently retract the brake pad assemblies away from the rotor.

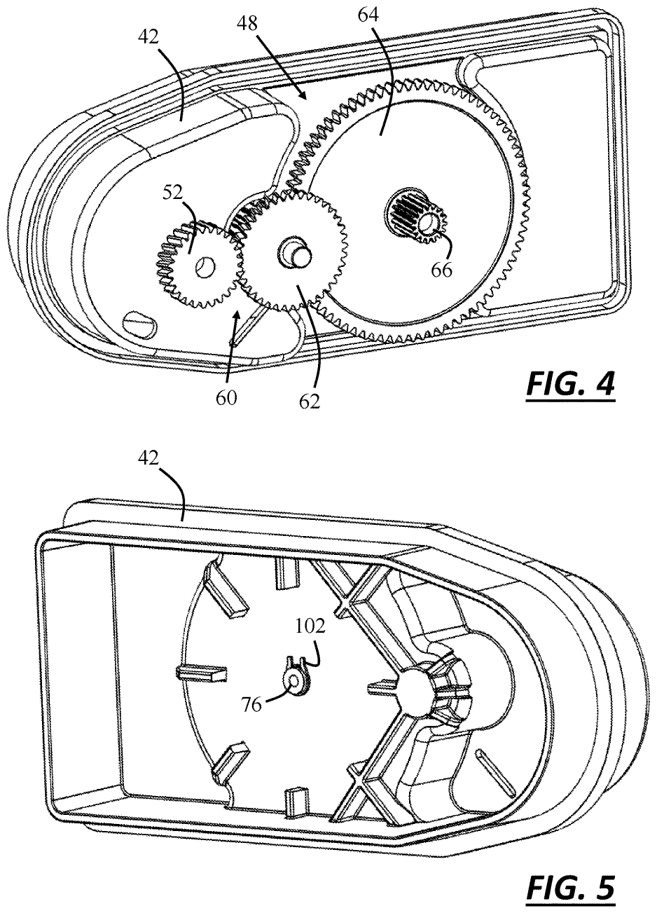

FIG. 4 illustrates a perspective view of the driving gear 64 of the brake system in accordance with the present teachings. As discussed above, the driving gear 64 may be in communication directly or indirectly with a motor output 52. The motor output 52 may be configured to transfer a torque generated by the motor directly or indirectly to the driving gear 64 so that the driving gear may transfer the torque generated through an output 66 and into a BNA of the brake system, thereby moving a piston towards a brake pad assembly during a brake apply operation.

In certain circumstances, the motor output 52 may be in direct communication with the driving gear 64. For example, the motor output 52 may be a gear having a plurality of teeth meshed with a plurality of teeth of the driving gear 64. As a result, rotation of the motor output 52 caused by the motor may translate directly to rotation of the driving gear and the output 66 therein.

However, as shown in FIG. 4, the motor output 52 may indirectly drive the driving gear 64 through a gear train 60. The gear train 60 may include one or more gears 62 that receive the torque through the motor output 52. The torque may then travel through the gear train 60 until it reaches the driving gear 64. Additionally, the driving gear 64, one or more gears 62 within the gear train 60, the motor output 52, or a combination thereof may be at least partially contained within one or more portions of a motor gear unit (MGU) housing 42. For example, while only a portion of the MGU housing 42 is shown in FIG. 4, it can be seen that at least the driving gear 64 may be at least partially contained within a groove 48 of the MGU housing 42. Similarly, a plate (not shown) located between the driving gear 64 and the MGU housing 42 may also be located within the groove 48.

FIG. 5 illustrates a perspective view of the motor gear unit (MGU) housing 42 with the cover removed. The view as shown illustrates an opposing side of the MGU housing 42 to that shown in FIG. 4.

As stated above, a plate may be located between the driving gear and the MGU housing 42. As a result, a shaft 76 of the plate may extend through the MGU housing 42 so that a clip 102 may secure the MGU housing 42 to the shaft 76 of the plate, thereby allowing rotation of the plate and/or the driving gear while maintain a lateral position of the plate, the driving gear, the MGU housing 42, or a combination thereof.

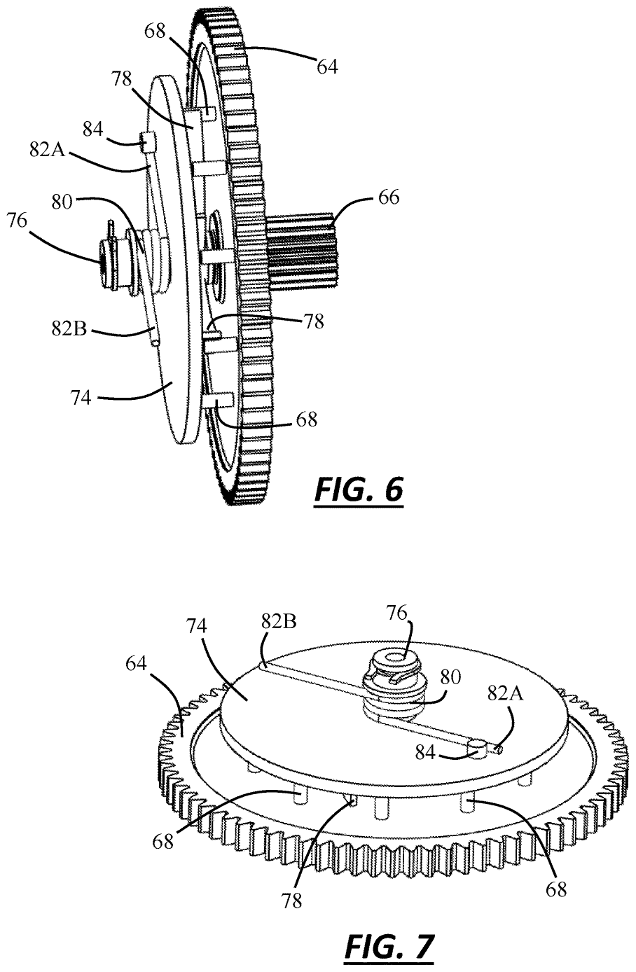

FIGS. 6 and 7 illustrate perspective views of the driving gear 64 in communication with the plate 74 of the brake system. As stated above, the driving gear 64 may include an output 66 adapted to communicate with the BNA of the brake system to drive the BNA during a brake apply operation, a release operation, or both. The output 66 may be a gear and/or shaft extending from the driving gear 64 that may transfer the torque generated through the driving gear 64 to the BNA, either directly or indirectly.

The driving gear 64 and the plate 74 may be rotatably engaged about a shaft 76 of the plate 74 extending through the plate 74. That is, the plate 74 and the driving gear 64 may rotate synchronously in the same direction, may rotate asynchronously in opposing directions, or both. For example, during a brake apply operation, the driving gear 64 may be driven to rotate in a first direction (e.g., clockwise) via the motor of the brake system. As the driving gear 64 rotates, pins 68 projecting from a surface of the driving gear 64 towards the plate 74 may contact one or more fins 78 along a surface of the plate 74 facing the driving gear 64. As a result, the pins 68 may in turn rotate the plate 74 with the driving gear 64 through the one or more fins 78.

As shown, the plate 74 may include a biasing member 80, such as a spring, at least partially wrapped around the shaft 76 of the plate 74. The biasing member 80 may include a first arm 82A with an opposing second arm 82B. The first arm 82A may abut or be otherwise fixed to a nib 84 projecting from a surface of the plate 74. Similarly, the second arm 82B may be located between or be fixed to an additional nib located on a secondary component, such as a surface of the motor gear unit (MGU) housing (see FIG. 12).

When the driving gear 64 engages the plate 74 so that the plate 74 rotates with the driving gear 64 (e.g., during a brake apply operation), the biasing member 80 may be wound (e.g., torqued). That is, due to the first arm 82A being fixed by contact with the nib 84 of the plate 74, the second arm 82B of the biasing member 80 may be free to rotate with the plate along an axis of rotation of the plate 74, the driving gear 64, or both, until the second arm 82B reaches a stopping point (see FIG. 12). Once the second arm 82B reaches the stopping point, the biasing member 80 may be fully wound.

The one or more fins 78 of the plate 74 may be elastic, compressible, or otherwise move so that, when the driving gear 64 is rotating with sufficient torque to overcome a designated threshold, the pins 68 may contact the one or more fins 78 and deflect the one or more fins 78 to allow for the driving gear 64 to continue to rotate. Such threshold for torque generated by the driving gear 64 to deflect the one or more fins 78 may be accomplished during the brake apply operation after the second arm 82B of the biasing member 80 has reached its stopping point. That is, when the second 82B prevents further winding of the biasing member 80, the pins 68 of the driving gear 64 may deflect the one or more fins 78 and allow the driving gear 64 to continue to rotate to drive the BNA of the brake system.

During a release operation, the drive gear 64 may begin to rotate in an opposing direction to a direction of rotation during the brake apply operation. Movement of the drive gear 64 in the release direction during normal operation of the brake system may be drive by the motor of the brake system through the planetary gears (see FIG. 2). Additionally, the BNA may be adapted to allow for backdrive, whereby the BNA itself begins to move in a release direction, thereby also driving the driving gear 64 in the release direction.

However, during a motor failure, the motor may be unable to move the drive gear 64—and thus the BNA—in a release direction to disengage the piston from the one or more brake pad assemblies of the brake system (see FIG. 3). As a result, the one or more brake pad assemblies must conventionally rely only on the backdrive created by the BNA. Unfortunately, such backdrive may typically be insufficient to release the brake pad assemblies from contacting a rotor of the vehicle. As a result, a drag condition may exist due to the contact, thereby degrading the rotor, the one or more brake pad assemblies, or both during operation of the vehicle.

Beneficially, the present design facilitates use of the biasing member 80 to increase a backdrive force and accommodate for the motor failure. More specifically, as described above, the biasing member 80 may be wound to store energy during the brake apply operation. During the release operation, the stored energy in the biasing member 80 may be free to release, thereby unwinding the biasing member 80 to bring the biasing member 80 back to an original position prior to winding. During such unwinding, the second arm 82B of the biasing member may release from the stop point reached during brake apply to rotate the plate 74 in the release direction. As a result, the one or more fins 78 of the plate 74 may contact the pins 68 of the driving gear 64 and cause the driving gear 64 to also rotate in the release direction, thereby driving the BNA to retract from engaging the piston. The biasing member 80 may continue to unwind and release its stored energy until the second arm 82B reaches its original position. The original position may be a second nib on the MGU housing or other position in which the second arm 82B is prevented from further movement in the release direction. Thus, based on the above, the biasing member 80 working on conjunction with the backdrive of the BNA may be sufficient to release the one or more brake pad assemblies from contacting the rotor, even during a motor failure. However, it should also be noted that the biasing member 80 may also working in conjunction with the backdrive of the BNA and a release torque generated by the motor during normal operating conditions to release the one or more brake pad assemblies. As a result, the biasing member 80 may advantageously improve the efficiency of the release operation even during normal operation.

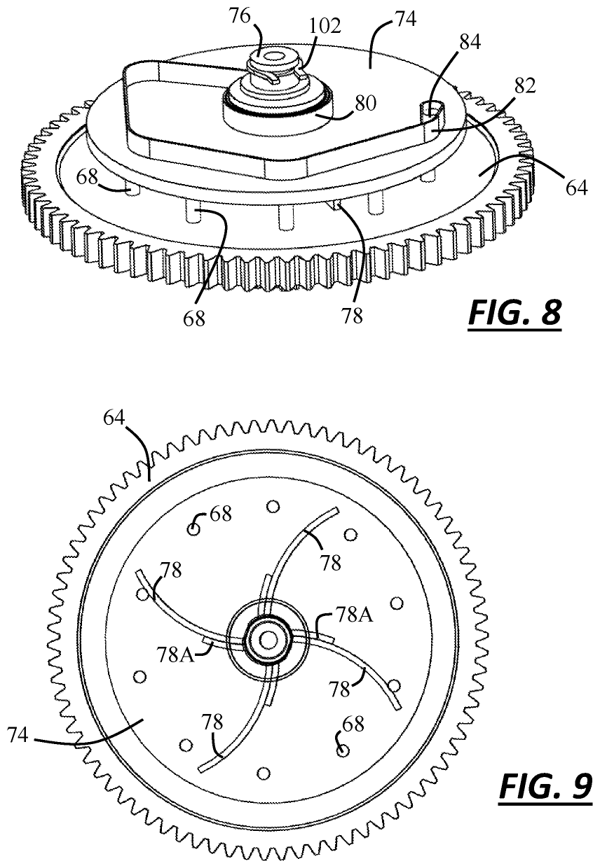

FIG. 8 illustrates a perspective view of a of a driving gear 64 in communication with a plate 74 of a brake system. As mentioned above, the driving gear 64 may include a plurality of pins 68 projecting from a surface of the driving gear 64 towards the plate 74. The pins 68 may be adapted to contact one or more fins 78 during rotation such that rotation of the driving gear 64 may rotate the plate 74. Furthermore, similar to the plate 74 shown in FIGS. 6 and 7, the plate 74 may include a biasing member 80 at least partially wrapped around a shaft 76 of the plate 74 and axially secured in place by a clip 102.

However, while the plate 74 shown in FIGS. 6 and 7 includes a torsion spring as a biasing member 80, the present plate 74 includes a coil spring wrapped around the shaft 76 of the plate 74. The biasing member 80 may include an arm 82 that extends to connect to a nib 84 on the plate 74. The arm 82, though not shown, may also abut or be otherwise routed along a surface of the plate 74 by one or more additional projections 84. For example, the arm 82 may extend around a plurality of projections until it reaches the nib 84 for connection.

During a brake apply operation, the driving gear 64 may rotate so that the pins 68 contact the one or more fins 78 of the plate 74, thereby rotating the plate 74 with the driving gear 64. As the plate 74 rotates, the biasing member 80 may also rotate to further wind a coiled portion of the biasing member 80 located about the shaft of the plate 74. Such winding may continue until a force to further wind the biasing member 80 passes a threshold for deflection of the one or more fins 78, at which point the pins 68 may deflect the one or more fins 78 to allow the driving gear 64 to continue rotating while the biasing member 80 remains wound.

Similarly, it is also envisioned that the biasing member 80 may be elastic so that rotation of the plate 74 may stretch the arm 82 and increase tension therein. However, such elasticity is not necessary to operate the biasing member 80 as described above.

During a release operation, the plate 74 may be free to rotate in a direction opposite to the direction during the brake apply operation. As a result, the biasing member 80 is also free to unwind to release the stored energy gained during the brake apply operation. Thus, the biasing member 80 may aid in rotation of the plate 74. As the plate 74 rotates, the one or more fins 78 thereon may contact the pins 68 of the driving gear 64, thereby also rotating the driving gear 64 along with the plate 74.

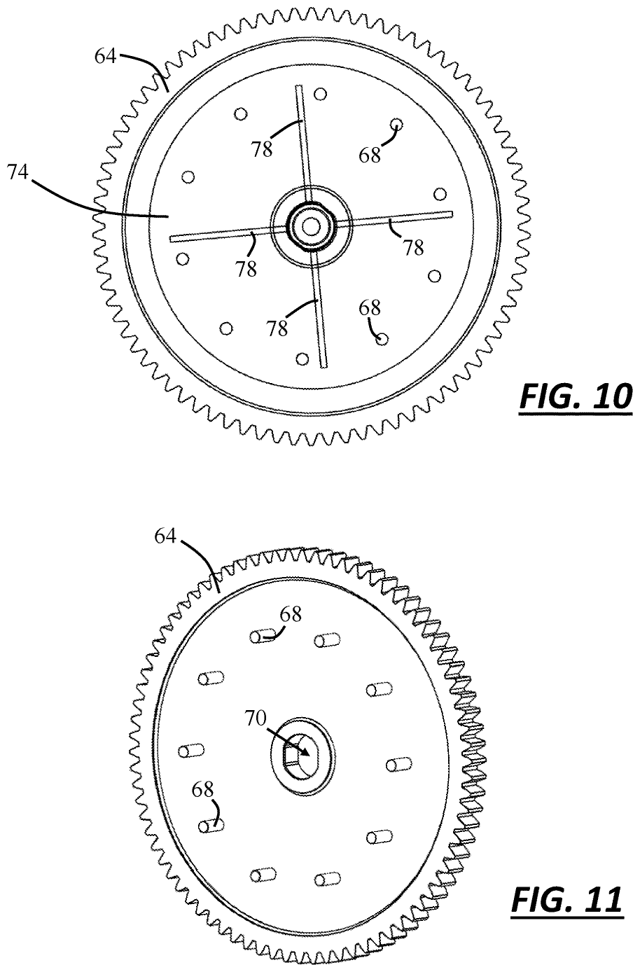

FIGS. 9 and 10 illustrate perspective views of a driving gear 64 in communication with a plate 74 of a brake system. The driving gears 64 in each figure have been made transparent to better illustrate communication between the driving gear 64 and the plate 74.

As shown, the driving gears 64 may include a plurality of pins 68 located around a surface of the plate 74. The pins 68 may be positioned radially away from an axis of the driving gear 64 so that a distance away from the axis of the driving gear 64 for each pin 68 is consistent. However, the pins 68 may also be positioned in any desired manner, whether uniform, patterned, in a varying manner, or a combination thereof. For example, the pins 68 may be spaced apart in a uniform manner around an entirety of the circumference of the driving gear 64. However, the pins 68 could also include one or more dissimilar gaps between pins 68 such that the pins 68 are not equally spaced apart around the circumference of the driving gear 64. Moreover, the pins 68 may also be positioned anywhere along the surface of the driving gear 64.

During rotation of the driving gear 64, the pins 68 may contact the plurality of fins 78 of the plate 74. The fins 78 may extend radially from an axis of the plate 74. Similarly, the fins 78 may be spaced apart in a uniform manner, however such spacing may not be necessary.

As shown in FIG. 9, the fins 78 may include a curvature or arcuate segment along the fins 78. The fins 78 may also include a reinforcement portion 78A to locally reinforce a portion of the fins 78 and improve structural integrity of the fins 78. However, such local reinforcement may not exist depending on a given application.

Conversely, as shown in FIG. 10, the fins 78 may also be substantially linear segments or projections along the plate 74 free of curvature or arcuate segments. Thus, it may be gleaned from the present teachings that a variety of shapes may be implemented for the fins 78. As a result, the fins 78 may be turned to adjust a threshold for deflection of the fins 78 by the pins 68 during operation of the brake system. Therefore, the fins 78 may beneficially accommodate various types of brake systems having varying forces applied therein.

FIG. 11 illustrates a perspective view of a driving gear 64. The driving gear 64 may include a plurality of pins 68 projecting from a surface to engage the fins of a plate (see, e.g., FIGS. 6-10). Furthermore, the driving gear 64 may include a hole 70 located about an axis of the driving gear 64. The hole 70 may be round or may include one or more anti-rotation features therein. For example, as shown, the hole 70 may include one or more flat segments that engage an output of the driving gear 64 so that rotation of the driving gear 64 may thereby rotate the output (see FIG. 3). Such output may be a gear or shaft. Similarly, the hole 70 of the driving gear 64 may also at least partially receive a shaft of the plate so that the driving gear 64 and the shaft may be free to rotate together or relative to each other about the same axis of rotation.

FIG. 12 illustrates a perspective view of the plate 74 of the brake system secured to the motor gear unit (MGU) housing 42. The housing 42 has been made transparent to further illustrate engagement with the plate 74.

As discussed in detail above, the plate 74 may include a biasing member 80 positioned around a shaft 76 of the plate 74. The biasing member may be positioned between a surface of the housing 42 and a surface of the plate 74, whereby the shaft 76 may extend through the housing 42 so that the housing 42 is secured to the shaft 76 by a clip 102.

The biasing member 80 may include a first arm 82A and an opposing second arm 82B. The first arm 82A may be fixed to a nib 84 located on the plate or be fixed in position in any desired manner. Conversely, the second arm 82B may be free to rotate between a first nib 86A of the housing 42 and a second nib 86B of the housing 42. For example, the second arm 82B may abut the first nib 86A of the housing 42 in a resting position prior to a brake apply operation. During the brake apply operation, the biasing member 80 may be wound to load the biasing member 80 with a force. The biasing member 80 may continue to wind due to the first arm 82A being secured to the nib 84 of the plate 74 until the second arm 82B moves away from the first nib 86A of the housing and reaches the second nib 86B of the housing, at which point further winding is prevented.

Conversely, during a release operation, the biasing member 80 may be free to unwind and rotate the plate 74 in a release direction until the second arm 82B moves back to its original position in contact with the first nib 86A of the housing 42, thereby preventing further rotation of the second arm 82B in the release direction.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer or section below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosures of all articles and references, including patent applications and publications, are incorporated by reference in their entireties for all purposes. Other combinations are also possible as will be gleaned from the following claims, which are also hereby incorporated by reference into this written description.

Unless otherwise stated, a teaching with the term “about” or “approximately” in combination with a numerical amount encompasses a teaching of the recited amount, as well as approximations of that recited amount. By way of example, a teaching of “about 100” encompasses a teaching of within a range of 100 +/−15.

### ELEMENT LIST

20 Brake System
22 Caliper Housing
24 Brake Pad Assembly
24A First Brake Pad Assembly
24B Second Brake Pad Assembly
26 Pressure Plate
28 Friction Material
30 Shim
34 Piston Housing
36 Piston
40 Motor Gear Unit (MGU)
42 Motor Gear Unit (MGU) Housing
44 Cover
46 Housing Fastener
48 Groove
50 Motor
52 Motor Output
54 Spindle and Nut Assembly
56 Spindle
56A Engaging Portion of the Spindle
58 Nut
58A Contact Surface of the Nut
60 Gear Train
62 Gear
64 Driving Gear
66 Output of the Driving Gear
68 Pin of the Driving Gear
70 Hole of the Driving Gear
72 Planetary Gear System
74 Plate
76 Shaft of the Plate
78 Fin of the Plate
78A Reinforcement of the Fin
80 Biasing Member
82 Arm of the Biasing Member
82A First Arm of the Biasing Member
82B Second Arm of the Biasing Member
84 Nib of the Plate
86 Nib of the Housing
86A First Nib of the Housing
86B Second Nib of the Housing
100 Ball Spring
102 Clip
A1 Axis of Rotation of the Motor
A2 Axis of Rotation of the Driving Gear
C Clamping Direction of the First Brake Pad Assembly
R Release Direction of the First Brake Pad Assembly

What is claimed is:

1. A brake system comprising:
(a) a caliper housing supporting a brake pad assembly in communication with a piston;
(b) a motor gear unit having a motor in communication with a driving gear, wherein during a brake apply operation or a brake release operation, the driving gear moves the brake pad assembly based on power received by the motor; and
(c) a plate in communication with the driving gear, wherein the plate creates a backdrive force to move the driving gear during the brake release operation, and in turn, directly or indirectly move the brake pad assembly.

2. The brake system of claim 1, wherein the backdrive force created by the plate is sufficient to retract the brake pad assembly from a rotor of a vehicle when a motor failure occurs to reduce or eliminate a force applied to the rotor by the brake pad assembly.

3. The brake system of claim wherein the plate is adapted to rotate with the driving gear during the brake apply operation, the brake release operation, or both.

4. The brake system of claim 3, wherein the plate is adapted to rotate independent of the driving gear, or vice versa, during the brake apply operation, the brake release operation, or both.

5. The brake system of claim 4, wherein the plate and the driving gear are coaxial.

6. The brake system of claim 5, wherein the driving gear includes a plurality of pins or projections extending from a surface of the driving gear that interact with one or more fins extending from a surface of the plate.

7. The brake system of claim 6, wherein the plurality of pins contact the one or more fins during the brake apply operation, the brake release operation, or both, so that rotation of the driving gear causes rotation of the plate.

8. The brake system of claim 1, wherein the plate includes a biasing member, and the biasing member is wound during the brake apply operation so that, during the brake release operation, the biasing member releases the backdrive force to move the driving gear.

9. The brake system of claim 8, wherein the biasing member includes a first arm secured by a nib of the plate and a second arm free to move between a pair of stopping points.

10. The brake system of claim 9, wherein a first stopping point is an initial position of the second arm prior to winding of the biasing member, and a second stopping point is a final position reached by the second arm when the biasing member has been fully wound.

11. The brake system of claim 10, wherein when the second arm reaches the second stopping point during the brake apply operation, the plurality of pins of the driving gear deflect the one or more fins of the plate, thereby allowing the driving gear to continue to rotate independent of the plate.

12. The brake system of claim 11, wherein the biasing member is secured around a shaft of the plate.

13. The brake system of claim 12, wherein the biasing member is located on an opposing surface of the plate to the surface containing the one or more fins.

14. The brake system of claim 13, wherein during the brake release operation, the release of the backdrive force by the biasing member causes the one or more fins of the plate to rotate and contact the plurality of pins of the driving gear, thereby causing the driving gear to also rotate in the same direction of the plate.

15. The brake system of claim 1, wherein the brake system includes a gear train between the motor and the driving gear, and torque generated by the motor is transferred through the gear train to the driving gear.

16. The brake system of claim 15, wherein the motor includes a motor output in communication with the gear train, and an axis of rotation of the motor output is parallel or perpendicular to an axis of rotation of the driving gear.

17. The brake system of claim 16, wherein the driving gear is in communication with a ball and nut assembly so that, during the brake apply operation, the driving gear drives the ball and nut assembly to contact the piston, whereby the piston contacts the brake pad assembly to move the brake pad assembly towards the rotor of the vehicle.

18. The brake system of claim 17, wherein the shaft of the plate is secured to a housing of the motor gear unit by a clip.

19. The brake system of claim 18, wherein the pair of stopping points are nibs located on the housing of the motor gear unit.

20. The brake system of claim 1, wherein the driving gear includes an output shaft extending from a surface of the driving gear that outputs the power received by the motor to move the brake pad assembly, and the plate is located adjacent to an opposing surface of the driving gear.
